(19) United States
(12) Patent Application Publication
(10) Pub. No.: US 2026/0355042 A1
(43) Pub. Date: Nov. 12, 2026

(54) METHOD FOR CONTROLLING WEARABLE DEVICE CONFIGURED TO PERFORM WEARING DETECTION FUNCTION AND WEARABLE DEVICE CONFIGURED TO PERFORM SAME

(71) Applicant: Samsung Electronics Co., Ltd., Suwon-si (KR)

(72) Inventor: Taehyun LEE, Suwon-si (KR)

(21) Appl. No.: 19/631,998

(22) Filed: Mar. 27, 2026

Related U.S. Application Data
(63) Continuation of application No. PCT/KR2024/014714, filed on Sep. 27, 2024.

(30) Foreign Application Priority Data
Dec. 10, 2023 (KR) 10-2023-0137683

(51) Int. Cl. A61H 3/00; A61H 1/02

(52) U.S. Cl. CPC A61H 3/00; A61H 1/0244; A61H 2003/007; A61H 2201/0192; A61H 2201/1642; A61H 2201/165; A61H 2201/1676; A61H 2201/5007; A61H 2201/5048; A61H 2201/5061; A61H 2201/5071

(57) ABSTRACT

A method for controlling a wearable device configured to perform a wearing detection function, and/or a wearable device configured to perform same. The method of controlling a wearable device may include: acquiring sensor data including pressure values between a thigh fastener of the wearable device and the user's leg from a first pressure sensor; determining whether the wearable device is properly worn by the user based on the sensor data; and changing the operating mode of the wearable device to an active mode in response to a determination that the wearable device is properly worn by the user.

### CROSS-REFERENCE TO RELATED APPLICATIONS

This application is a continuation application of International Application No. PCT/KR2024/014714, filed on Sept. 27, 2024, in the Korean Intellectual Property Receiving Office, and claiming priority to KR Application No. 10-2023-0137683 filed Oct. 16, 2023, the disclosures of which are all hereby incorporated by reference herein in their entireties.

### TECHNICAL FIELD

[1] Certain example embodiments may relate to a method for controlling a wearable device configured to perform a wearing detection function, and/or a wearable device configured to perform the same.

### BACKGROUND

[2] In general, a walking assistance device may refer to a mechanism and/or device that helps a patient or other type of person, who cannot walk on his/her own due to various diseases, accidents, and the like, or who may wish to desire to exercise, to perform walking exercises for rehabilitation treatment and/or exercise, and/or a mechanism or device that can be used for such exercises. With the recent intensifying aging societies, a growing number of people experience inconvenience in walking or have difficulty in normal walking due to malfunctioning joint issues, and there is increasing interest in walking assistance devices. A walking assistance device may be mounted on the body of a user, for example, to assist the user with walking by providing a necessary muscular strength and to induce the user to walk in a normal walking pattern. Such a walking assistance device may also perform an exercise function to assist a user with various leg exercises (e.g., power walking, jogging, stair climbing, lunging, and stretching).

### SUMMARY

[3] A wearable device, according to an example embodiment, may include a driving module, including a motor and/or circuitry, configured to generate torque, a torque transmission frame configured to transmit the generated torque to a leg(s) of a user, a thigh fastener connected, directly or indirectly, to the torque transmission frame and configured to connect, directly or indirectly, the torque transmission frame to the leg(s) of the user, a first pressure sensor configured to output sensor data including a pressure value between the thigh fastener and the leg of the user, and one or more processors comprising processing circuitry. The one or more processors may be configured, individually and/or collectively, to acquire the sensor data from the first pressure sensor, determine, based on the sensor data, whether the wearable device is properly worn by the user, and change an operating mode of the wearable device to an active mode in response to a determination that the wearable device is properly worn by the user.

[4] A control method of a wearable device configured to perform a wearing detection function, according to an example embodiment, may include acquiring sensor data including a pressure value between a thigh fastener of the wearable device and a leg of a user from a first pressure sensor, determining, based on the sensor data, whether the wearable device is properly worn by the user, and changing an operating mode of the wearable device to an active mode in response to a determination that the wearable device is properly worn by the user.

### BRIEF DESCRIPTION OF DRAWINGS

[5] These and/or other aspects, features and advantages will become apparent and more readily understood from the following description of exemplary embodiments, taken in conjunction with the accompanying drawings.

[6] FIG. 1 is a diagram illustrating an overview of a wearable device worn on a body of a user according to an example embodiment.

[7] FIG. 2 is a diagram illustrating an exercise assistance system according to an example embodiment.

[8] FIG. 3 is a rear schematic view illustrating a wearable device according to an example embodiment.

[9] FIG. 4 is a left side view of a wearable device according to an example embodiment.

FIGS. 5A and 5B are diagrams illustrating components of a wearable device according to an example embodiment.

FIG. 6 is a diagram illustrating an interaction between a wearable device and an electronic device according to an example embodiment.

FIG. 7 is a diagram illustrating a wearing detection function of a wearable device according to an example embodiment.

FIG. 8 is a diagram illustrating an arrangement of a pressure sensor in a wearable device according to an example embodiment.

FIG. 9 is a diagram illustrating a proper wearing monitoring function of a wearable device after a start of an exercise program according to an example embodiment.

FIG. 10 is a diagram illustrating operations of a pressure sensor and a fastening adjuster of a wearable device according to an example embodiment.

FIG. 11 is a flowchart illustrating operations of a control method of a wearable device performing wearing detection function according to an example embodiment.

### DETAILED DESCRIPTION

The following detailed structural or functional description is provided as an example only and various alterations and modifications may be made to embodiments. Accordingly, the embodiments are not construed as limited to the disclosure and should be understood to include all changes, equivalents, and replacements within the idea and the technical scope of the disclosure.

As used herein, the singular forms "a," "an," and "the" are intended to include the plural forms as well, unless the context clearly indicates otherwise. It will be further understood that the terms "comprises" and/or "comprising," when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined, all terms used herein including technical or scientific terms have the same meaning as commonly understood by one of ordinary skill in the art to which embodiments belong. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments will be described in detail with reference to the accompanying drawings. When describing the embodiments with reference to the accompanying drawings, like reference numerals refer to like elements and a repeated description related thereto will be omitted.

FIG. 1 is a diagram illustrating an overview of a wearable device worn on a body of a user according to an embodiment.

Referring to FIG. 1, in an embodiment, a wearable device 100 may be a device worn on a body of a user 110 to assist the user 110 in walking, exercising, and/or working. The wearable device 100 may be used to measure a physical ability (e.g., a walking ability, an exercise ability, or an exercise posture) of the user 110. In embodiments, the term "wearable device" may be replaced with "wearable robot," "walking assistance device," or "exercise assistance device". The user 110 may be a person who walks or exercises while wearing the wearable device 100.

The wearable device 100 may be worn on the body (e.g., a lower body (legs, ankles, knees, etc.) or an upper body (a torso, a waist, arms, wrists, etc.) of the user 110 and may apply an external force, such as an assistance force and/or a resistance force, to a body motion of the user 110. The assistance force may be a force assisting the body motion of the user 110, which is applied in the same direction as a direction of the body motion of the user 110. The resistance force may be a force applied in a direction opposite to the body motion direction of the user 110, the force hindering a body motion of the user 110. The term "resistive force" may also be referred to as an "exercise load".

In an embodiment, the wearable device 100 may operate in a walking assistance mode for assisting the user 110 in walking. In the walking assistance mode, the wearable device 100 may assist the user 110 in walking by applying an assistance force generated by a driving module 120 of the wearable device 100 to the body of the user 110. The wearable device 100 may enable the user 110 to walk independently or to walk for a long time by providing a force required for the user 110 to walk, thereby expanding the walking ability of the user 110. The wearable device 100 may help in improving an abnormal walking habit or walking posture of a walker.

In an embodiment, the wearable device 100 may operate in an exercise assistance mode for enhancing the effect of exercise of the user 110 or providing various exercise experiences to the user 110. The exercise assistance mode may include a resistance mode and an assistance mode. The resistance mode may represent a mode for hindering a body motion of the user 110 or providing resistance to a body motion of the user 110 by applying a resistance force generated by the driving module 120 to the body of the user 110. When the wearable device 100 is a hip-type wearable device that is worn on the waist (or pelvis) and legs (e.g., thighs) of the user 110, the wearable device 100 may provide an exercise load to a leg motion of the user 110 while being worn on the legs in the resistance mode, thereby enhancing the effect of exercise on the legs of the user 110. The assistance mode may be a mode for applying an assistance force for assisting a body motion of the user 110 to the body of the user 110. In the assistance mode, an assistance force in the same direction as a body motion may be provided to the user 110. For example, when a person with a disability or an elderly person wears the wearable device 100 to exercise, the wearable device 100 may provide an assistance force to assist a body motion. In the assistance mode, the wearable device 100 may provide a force in the same direction as a direction of a leg motion of the user 110, and the user 110 may exercise with a small force. In an exercise program performed using the wearable device 100, the resistance mode and the assistance mode may be combined and operated. For example, the wearable device 100 may provide a combination of an assistance force and a resistance force for each exercise session or time interval in such a manner of providing an assistance force in an exercise session and providing a resistance force in another exercise session. In the exercise assistance mode, various exercise programs may be operated depending on the exercise purpose and/or a physical ability of the user 110. The exercise program may be exercise content that the user 110 performs using the wearable device 100 and may include, for example, cardio exercises, strength training, posture balancing, or any combination thereof. The type of the exercise program is not limited thereto and may be various. The resistance mode and the assistance mode may be alternately activated appropriately depending on an exercise program performed by the wearable device 100, and a target exercise speed that is suitable for an appropriate physical condition (e.g., a heart rate) of the user 110 may be guided to the user during the exercise of the user 110.

In an embodiment, the wearable device 100 may operate in a physical ability measurement mode for measuring a physical ability of the user 110. The wearable device 100 may measure motion information of the user 110 using a sensor (e.g., an angle sensor 125 and an inertia measurement unit (IMU) 135) provided in the wearable device 100 during the walking and/or exercise of the user 110 and may assess the physical ability of the user 110 based on the measured motion information. For example, a walking index (e.g., the number of walking steps, a total walking distance, and a stride length) or an exercise ability indicator (e.g., muscular strength, endurance, balance, or exercise motion) of the user 110 may be estimated through the motion information of the user 110 measured by the wearable device 100.

In some embodiments, the description is provided based on an example of the hip-type wearable device 100 as shown in FIG. 1. However, the embodiments are not limited thereto. As described above, the wearable device 100 may be worn on other body parts (e.g., upper arms, lower arms, hands, calves, or feet) other than the waist or legs (specifically, thighs). The shape and configuration of the wearable device 100 may vary depending on the body part on which the wearable device 100 is worn.

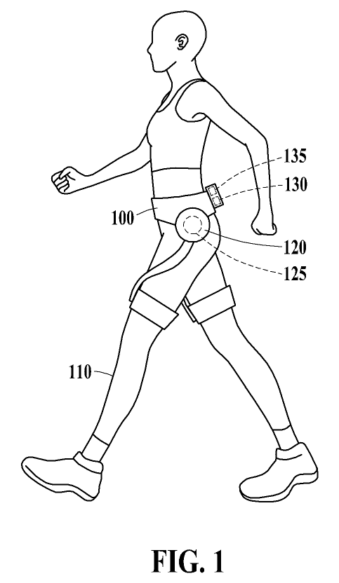

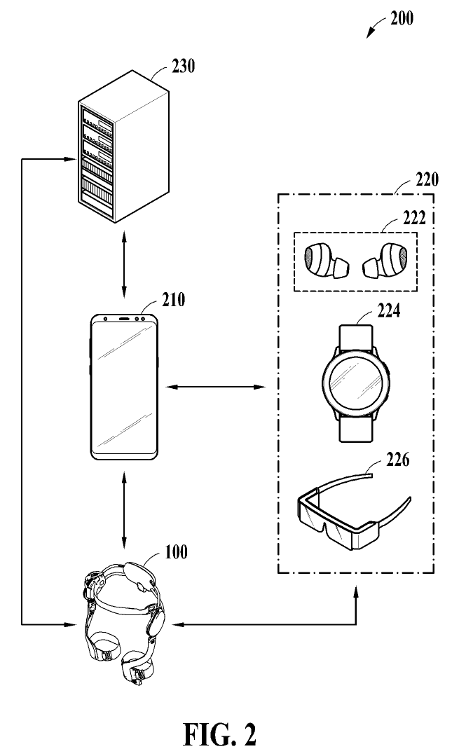

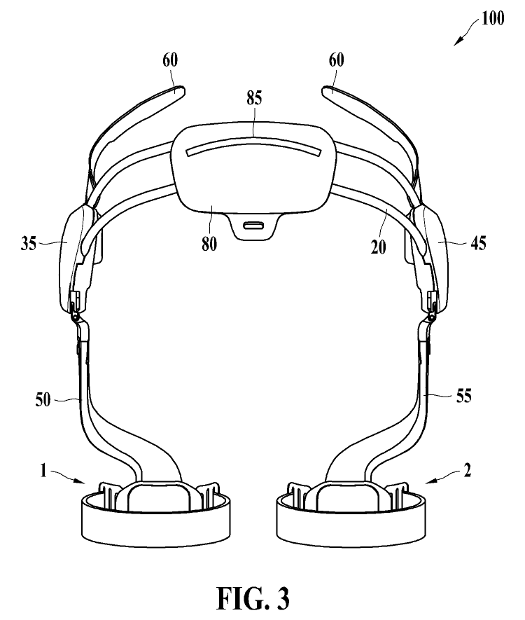

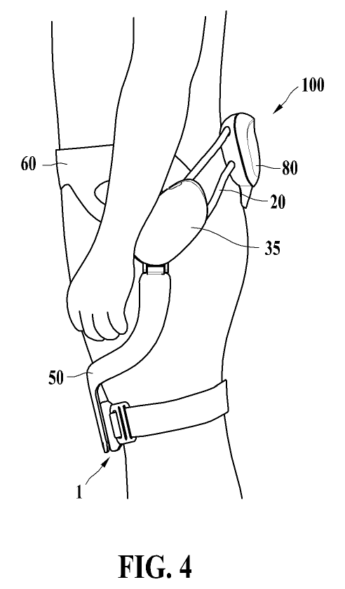

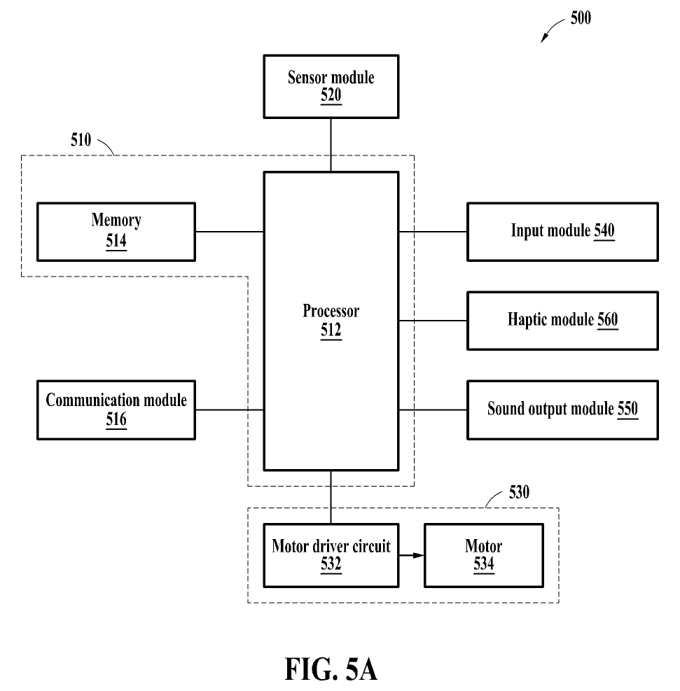

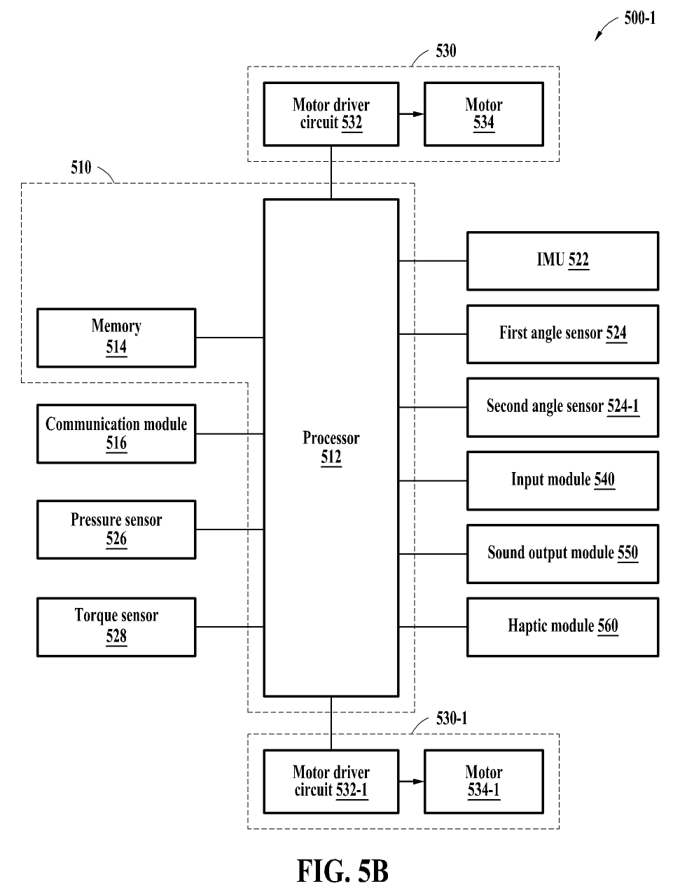

The wearable device 100 may include a support frame (e.g., a waist support frame 20 of FIGS. 3 and 4) for supporting the body of the user 110 when the wearable device 100 is worn on the body of the user 110, a driving module 120 (e.g., driving modules 35 and 45 of FIG. 3) configured to generate torque applied to legs of the user 110, a torque transmission frame (e.g., a first torque transmission frame 55 and a second torque transmission frame 50 of FIG. 3) configured to transmit torque generated by the driving module 120 to legs of the user 110, a sensor module (e.g., a sensor module 520 of FIG. 5A) including one or more sensors for obtaining sensor data including motion information about a body motion (e.g., a leg motion or an upper body motion) of the user 110, and a control module 130 (e.g., a control module 510 of FIGS. 5A and 5B) configured to control an operation of the wearable device 100.

In an embodiment, the wearable device 100 may include the angle sensor 125 and the IMU 135. The angle sensor 125 may measure a rotation angle of the torque transmission frame of the wearable device 100 corresponding to a hip joint angle of the user 110. The angle sensor 125 may include, for example, an encoder and/or a Hall sensor. In an embodiment, the angle sensor 125 may be disposed adjacent to a position where a motor included in the driving module 120 is connected, directly or indirectly, to the torque transmission frame. The IMU 135 may include an acceleration sensor and/or an angular velocity sensor, and may measure a change in acceleration and/or angular velocity according to a motion of the user 110. The IMU 135 may measure, for example, a motion value of a waist support frame (e.g., the waist support frame 20 of FIG. 3) or a base body (e.g., a base body 80 of FIG. 3) of the wearable device 100. The motion value of the waist support frame or the base body measured by the IMU 135 may correspond to a waist motion value (or an upper body motion value) of the user 110.

In an embodiment, the control module 130 and the IMU 135 may be arranged within the base body (e.g., the base body 80 of FIG. 3) of the wearable device 100. The base body may be on the waist of the user 110 while the user 110 is wearing the wearable device 100. The base body may be formed on or attached to an outer side of the waist support frame of the wearable device 100. The base body may support the lumbar region of the user 110.

In an embodiment, the wearable device 100 may provide haptic feedback to the user through a haptic module (e.g., a haptic module 560 of FIGS. 5A and 5B). The haptic module may include one or more haptic actuators configured to provide haptic feedback. The haptic feedback may be rapidly perceived by the user 110 without a separate confirmation procedure by the user 110 and may have an advantage over visual feedback and sound feedback because it is less limited by other factors, such as ambient noise.

For the user 110 to use the wearable device 100, the user 110 may need to wear the wearable device 100 and fasten the wearable device 100 to their body. The user 110 may wear the wearable device 100 to fit their body through a fastener including a belt and/or a band of the wearable device 100. For example, when the user 110 wears the wearable device 100, the user may fasten a waist fastener (e.g., a waist fastener 60 of FIGS. 3 and 4) of the wearable device 100 to fit the waist size of the user and may fasten both thigh fasteners (e.g., thigh fasteners 1 and 2 of FIGS. 3 and 4) to fit the sizes of both thighs. When the wearable device 100 worn on the body of the user 110 fits the body size of the user 110, an external force (or torque) generated by the wearable device 100 may be accurately and efficiently transmitted to the body of the user 110, and a safe operation of the wearable device 100 may be ensured.

According to various embodiments of the disclosure, the wearable device 100 may perform a wearing detection function to detect whether the wearable device 100 is properly (or correctly) worn on the body of the user 110. The wearable device 100 may perform the wearing detection function not only before the wearable device 100 performs a substantial application operation (e.g., performing an exercise program) but also while performing an application operation. In an embodiment, the wearable device 100 may include a pressure sensor configured to measure a pressure value between the body of the user 110 and the wearable device 100 at the fastener (e.g., the waist fastener or the thigh fastener) and/or the base body, and the control module 130 may determine, based on the measured pressure value, whether the wearable device 100 is properly worn on the body of the user 110. When the user 110 properly wears the wearable device 100, the wearable device 100 may be in close contact with the body of the user 110, and an output pressure value of the pressure sensor may be measured to be equal to or greater than a predetermined reference value. When the user 110 does not wear the wearable device 100 or does not properly wear the wearable device 100, the wearable device 100 may not be in close contact with the body of the user 110 or may be spaced apart from the body of the user 110, and an output pressure value of the pressure sensor may be measured to be less than the predetermined reference value. As such, the control module 130 may determine, based on characteristics of the pressure value measured by the pressure sensor, whether the wearable device 100 is in a state of being properly worn on the body of the user 110.

In an embodiment, the wearable device 100 may include a torque sensor (not shown) configured to measure a torque value, and the control module 130 may determine, based on the measured torque value, whether the wearable device 100 is properly worn on the body of the user 110. When the wearable device 100 is in a driving state in which torque is generated, a measured value obtained from the torque sensor may vary depending on a fastening state between the body of the user 110 and the fastener of the wearable device 100. When the user 110 properly wears the wearable device 100, the wearable device 100 may be in close contact with the body of the user 110, and an output torque value of the torque sensor may be measured to be equal to or greater than a predetermined reference value. When the user 110 does not properly wear the wearable device 100, the wearable device 100 may not be in close contact with the body of the user 110 or may be spaced apart from the body of the user 110, and an output torque value of the torque sensor may be measured to be less than the predetermined reference value or to have relatively large fluctuation. As such, the control module 130 may determine, based on a magnitude of the torque value measured by the torque sensor, whether the wearable device 100 is in a state of being properly worn on the body of the user 110.

In an embodiment, when the control module 130 determines that the wearable device 100 is properly worn on the body of the user 110, the control module 130 may allow the wearable device 100 to continue to operate or may allow initiation of an operation of the wearable device 100. When the control module 130 determines that the wearable device 100 is not properly worn on the body of the user 110, the control module 130 may prevent or reduce chances of the wearable device 100 from operating or may stop an operation of the wearable device 100 during operation. When the control module 130 determines that the wearable device 100 is not properly worn on the body of the user 110, the control module 130 may provide a guide notification (e.g., a guide voice and vibration feedback) to the user 110 to induce the user 110 to properly wear the wearable device 100. In an embodiment, the guide notification may be provided to the user 110 in a form of a voice or vibration feedback output from the wearable device 100 or in a form of a voice or a notification message output from a peripheral device (e.g., a wireless earphone, a smartwatch, or a smartphone) wirelessly connected to the wearable device 100. Through such control of the control module 130, when the wearable device 100 is not properly worn on the body of the user 110, the wearable device 100 may be prevented from moving or the user 110 may be induced to properly wear the wearable device 100, thereby reducing a possibility that the user 110 may be injured due to abnormal wearing of the wearable device 100.

FIG. 2 is a diagram illustrating an exercise assistance system according to an embodiment.

Referring to FIG. 2, an exercise assistance system 200 may include the wearable device 100, an electronic device (or a user terminal) 210, another wearable device 220, and a server 230. In the exercise assistance system 200, at least one of the devices (e.g., the electronic device 210, the other wearable device 220, and the server 230) other than the wearable device 100 may be omitted, or at least one device (e.g., a dedicated controller for the wearable device 100) may be added thereto.

In an embodiment, the wearable device 100 may be worn on a body of a user in the walking assistance mode to assist a motion of the user. For example, the wearable device 100 may be worn on the legs of the user to help the user in walking by generating an assistance force for assisting a leg motion of the user.

In an embodiment, the wearable device 100 may generate and apply a resistance force for hindering a body motion of the user and/or an assistance force for assisting a body motion of the user to the body of the user to enhance an effect of the user's exercise in the exercise assistance mode. In the exercise assistance mode, the user may select an exercise program (e.g., cardio exercise such as power walking and outdoor walking, strength training such as squats, split lunges, dumbbell squats, and lunge and knee ups, a stretching exercise, a posture balancing exercise, or any combination thereof) that the user desires to conduct using the wearable device 100 through the electronic device 210 and/or an exercise intensity applied to the exercise program. The wearable device 100 may control the driving module of the wearable device 100 according to the exercise program selected by the user. The wearable device 100 may adjust the strength of the resistance force and/or the assistance force applied to the user based on the exercise intensity selected by the user. For example, the wearable device 100 may control the driving module to generate a resistance force corresponding to the exercise intensity selected by the user. As the exercise intensity increases, the strength of the resistance force applied to the user may increase.

The wearable device 100 may transmit sensor data measured by a sensor (e.g., the angle sensor, or the IMU) to the electronic device 210 and may receive a control signal related to an operation of the wearable device 100 from the electronic device 210. The wearable device 100 may provide (or output) feedback (e.g., visual feedback, auditory feedback, or haptic feedback) corresponding to the state of the wearable device 100 according to the control signal received from the electronic device 210. For example, the wearable device 100 may provide the visual feedback through a lighting unit (e.g., a lighting unit 85 of FIG. 3) and the auditory feedback through a sound output module (e.g., a sound output module 550 of FIGS. 5A and 5B).

The electronic device 210 may communicate with the wearable device 100 through wireless communication and may remotely control the wearable device 100 or provide the user with state information about a state (e.g., a booting state, a charging state, a sensing state, or an error state) of the wearable device 100. The electronic device 210 may recommend an exercise program using the wearable device 100 to the user and may analyze an exercise performed by the user. The electronic device 210 may receive sensor data obtained by the sensor of the wearable device 100 from the wearable device 100, and estimate a current exercise state, an exercise result, an exercise posture, and/or a physical ability of the user based on the received sensor data. The electronic device 210 may provide the user with the estimated current exercise state, exercise result, exercise posture, and/or physical ability of the user through a graphical user interface (GUI).

In an embodiment, the user may execute a program (e.g., an application) in the electronic device 210 to control the wearable device 100 and may adjust an operation or a setting value (e.g., a torque magnitude output by a motor of a driving module, a volume of audio output by a sound output module, and brightness of a lighting unit) of the wearable device 100 through the program. The program executed by the electronic device 210 may provide a GUI for an interaction with the user. The electronic device 210 may include various types of devices. For example, the electronic device 210 may include a portable communication device (e.g., a smartphone), a computer device, a portable multimedia device, or a home appliance (e.g., a television, an audio device, or a projector device), but is not limited thereto.

According to an embodiment, the electronic device 210 may be connected to the server 230 using short-range wireless communication or cellular communication. The server 230 may receive user profile information of the user who uses the wearable device 100 from the electronic device 210 and store and manage the received user profile information. The user profile information may include, for example, information about at least one of the name, age, gender, height, weight, medical history, or body mass index (BMI). The server 230 may receive exercise history information about an exercise performed by the user from the electronic device 210 and store and manage the received exercise history information. The server 230 may provide the electronic device 210 with various exercise programs or physical ability measurement programs to be provided to the user. In an embodiment, the server 230 may be connected, directly or indirectly, to the wearable device 100. The server 230 may receive, from the wearable device 100, the sensor data measured by the wearable device 100 and transmit, to the wearable device 100, a control signal for controlling an operation of the wearable device 100 and/or data related to the exercise program. In an embodiment, the server 230 may be a cloud server.

According to an embodiment, the wearable device 100 and/or the electronic device 210 may be connected to the other wearable devices 220. Exercise result information, physical ability information, and/or exercise posture assessment information of the user that are determined by the electronic device 210 may be transmitted to the other wearable device 220 and provided to the user through the other wearable device 220. State information of the wearable device 100 may also be transmitted to the other wearable device 220 and provided to the user through the other wearable device 220. In an embodiment, the wearable device 100, the electronic device 210, and the other wearable device 220 may be connected to each other through wireless communication (e.g., Bluetooth communication or wireless fidelity (Wi-Fi) communication). The other wearable device 220 may be, for example, wireless earphones 222, a smartwatch (or a watch-type wearable device) 224, or smartglasses (a wearable device in the type of glasses or goggles) 226, but is not limited thereto.

In an embodiment, the wireless earphones 222 may be wirelessly connected to the electronic device 210 and/or the wearable device 100 and may output a guiding voice, music, and/or sound effect related to the exercise program. The wireless earphones 222 may provide information related to the exercise program (e.g., introduction of the exercise program or a remaining exercise time) to the user or inquire about a selection of the user through the guiding voice. The wireless earphones 222 may include a microphone, and the microphone may receive a voice input from the user. The voice input received through the microphone may be transmitted to the electronic device 210, and voice recognition for the voice input may be performed by the electronic device 210.

In an embodiment, the smartwatch 224 may include a biometric sensor (e.g., a heart rate sensor or an electromyography sensor) configured to measure a biosignal, including heart rate information of the user, and transmit the biosignal measured by the biometric sensor to the electronic device 210 and/or the wearable device 100. For example, the electronic device 210 may estimate the heart rate information (e.g., the current heart rate, the maximum heart rate, and the average heart rate) and/or electromyography information of the user based on the biosignal received from the smartwatch 224, and provide the user with the estimated heart rate information and/or electromyography information. The heart rate information and/or the electromyography information may be used to determine the haptic intensity of haptic feedback provided through the wearable device 100.

In an embodiment, the smartwatch 224 may include an IMU configured to measure motion information of the user and/or a position sensor configured to measure position information of the user, and transmit the motion information and/or position information of the user to the electronic device 210 and/or the wearable device 100. The smartwatch 224 may include a communication module (e.g., a short-range communication module) for communicating with another device (e.g., the electronic device 210 and the wearable device 100). In an embodiment, the smartwatch 224 may provide an interface related to an exercise program through a display. The interface related to the exercise program may be implemented through a separate application installed on the smartwatch 224. The user may also control the wearable device 100 through the smartwatch 224.

In an embodiment, the smartglasses 226 may provide information to the user through a display in the form of glasses. For example, the smartglasses 226 may output information about the current exercise speed, a target exercise speed, the currently achieved exercise amount, the exercise time, and the biometric information, through the display in an exercise mode. In addition, the smartglasses 226 may output a screen for guiding the user with an exercise path.

FIG. 3 is a rear schematic view illustrating a wearable device according to an embodiment. FIG. 4 is a left side view of a wearable device according to an embodiment.

Referring to FIGS. 3 and 4, the wearable device 100, according to an embodiment, may include the base body 80, the waist support frame 20, the driving modules 35 and 45, the torque transmission frames 50 and 55, the thigh fasteners 1 and 2, and the waist fastener 60. The base body 80 may include a lighting unit 85. In an embodiment, at least one (e.g., the lighting unit 85) of the components described above may be omitted from the wearable device 100, or one or more other components may be added to the wearable device 100.

The base body 80 may be positioned on the lumbar region of a user while the user is wearing the wearable device 100. The base body 80 may be mounted on the lumbar region of the user to provide a cushioning feeling to the lower back of the user and may support the lower back of the user. The base body 80 may be hung on the hip region (an area of the hips) to prevent or reduce chances of the wearable device 100 from being separated downward due to gravity while the user is wearing the wearable device 100. The base body 80 may distribute a portion of a weight of the wearable device 100 to the lower back of the user while the user is wearing the wearable device 100. The base body 80 may be connected, directly or indirectly, to the waist support frame 20. Waist support frame connecting elements (not shown) to be connected, directly or indirectly, to the waist support frame 20 may be provided at both end portions of the base body 80.

In an embodiment, the lighting unit 85 may be provided on the outer surface of the base body 80. The lighting unit 85 may include a light source (e.g., a light-emitting diode (LED)). The lighting unit 85 may emit light in response to a control of a processor (not shown) (e.g., a processor 512 of FIGS. 5A and 5B) of the wearable device 100. In some embodiments, the lighting unit 85 may be controlled to provide (or output) visual feedback corresponding to the state of the wearable device 100 through the lighting unit 85.

In an embodiment, a display (not shown) may be provided on the outer surface of the base body 80. The display may provide a screen for various pieces of visual information related to the wearable device 100 (e.g., state information of the wearable device 100) and a user interface (UI).

The waist support frame 20 may support a body part (e.g., the waist) of the user when the wearable device 100 is worn on the body of the user. The waist support frame 20 may extend from both end portions of the base body 80. The lumbar region of the user may be accommodated inside the waist support frame 20. The waist support frame 20 may include at least one rigid body beam. Each beam may be in a curved shape having a preset curvature to enclose the lumbar region of the user. The waist fastener 60 may be connected, directly or indirectly, to an end portion of the waist support frame 20. The driving modules 35 and 45 may be directly or indirectly connected to the waist support frame 20.

In an embodiment, a processor comprising processing circuitry, a memory (e.g., a memory 514 of FIGS. 5A and 5B), an IMU (e.g., the IMU 135 of FIG. 1 and an IMU 522 of FIG. 5B), a communication module (e.g., a communication module 516 of FIGS. 5A and 5B, comprising communication circuitry), a sound output module (e.g., a sound output module 550 of FIGS. 5A and 5B), and a battery (not shown) may be disposed in the base body 80. The base body 80 may protect the components disposed therein. The processor may generate a control signal for controlling the operation of the wearable device 100. The processor may control a motor (or an actuator) of the driving module 35 or 45 configured to generate torque based on electrical energy stored in the battery. The processor and the memory may be included in control circuitry. The control circuitry may further include a power supply circuit configured to supply power from the battery to each of the components of the wearable device 100.

In an embodiment, the wearable device 100 may include a sensor module (not shown) (e.g., the sensor module 520 of FIG. 5A) configured to obtain sensor data from one or more sensors. The sensor module may obtain sensor data including motion information of the user and/or motion information of the components of the wearable device 100. The sensor module may include, for example, an IMU (e.g., the IMU 135 of FIG. 1 or an IMU 522 of FIG. 5B) configured to measure a motion value of the upper body of the user or a motion value of the waist support frame 20, an angle sensor (e.g., the angle sensor 125 of FIG. 1, or a first angle sensor 524 and a second angle sensor 524-1 of FIG. 5B) configured to measure a hip joint angle value of the user or a motion value of the torque transmission frames 50 and 55, a pressure sensor (e.g., a pressure sensor 526 of FIG. 5B) configured to measure a pressure value, and/or a torque sensor (e.g., a torque sensor 528 of FIG. 5B) configured to measure a torque value, but is not limited thereto. For example, the sensor module may further include at least one of a position sensor, a temperature sensor, a biosignal sensor, a distance sensor, or a proximity sensor.

The waist fastener 60 may be connected, directly or indirectly, to the waist support frame 20 to fasten the waist support frame 20 to the waist of the user. The waist fastener 60 may include, for example, a pair of belts.

The driving modules 35 and 45 may generate an external force (or torque) to be applied to the body of the user, based on the control signal generated by the processor. “Based on” as used herein covers based at least on. For example, the driving modules 35 and 45 may generate an assistance force or resistance force to be applied to the legs of the user. In an embodiment, the driving modules 35 and 45 may include a first driving module 45 disposed in a position corresponding to a position of a right hip joint of the user, and a second driving module 35 disposed in a position corresponding to a position of a left hip joint of the user. The first driving module 45 may include a first actuator and a first joint member, and the second driving module 35 may include a second actuator and a second joint member. The first actuator may provide power to be transmitted to the first joint member, and the second actuator may provide power to be transmitted to the second joint member. The first actuator and the second actuator may each include a motor configured to generate power (or torque) by receiving power from the battery. When the motor is driven as the power is supplied thereto, the motor may generate a force (an assistance force) for assisting a body motion of the user or a force (a resistance force) for hindering a body motion of the user. In an embodiment, the control module may adjust the strength and direction of the force generated by the motor by adjusting the voltage and/or current supplied to the motor.

In an embodiment, the first joint member and the second joint member may receive power from the first actuator and the second actuator, respectively, and apply an external force to the body of the user based on the received power. In an embodiment, the first joint member and the second joint member may be disposed at positions corresponding to the joints of the user, respectively. One side of the first joint member may be directly or indirectly connected to the first actuator, and the other side of the first joint member may be directly or indirectly connected to the first torque transmission frame 55. The first joint member may be rotated by the power received from the first actuator. An encoder or a Hall sensor that may operate as an angle sensor to measure a rotation angle (corresponding to a joint angle of the user) of the first joint member or the first torque transmission frame 55 may disposed on one side of the first joint member. One side of the second joint member may be connected to the second actuator, and the other side of the second joint member may be connected to the second torque transmission frame 50. The second joint member may be rotated by the power received from the second actuator. An encoder or a Hall sensor that may operate as an angle sensor to measure a rotation angle of the second joint member or the second torque transmission frame 50 may be disposed on one side of the second joint member.

In an embodiment, the first actuator may be disposed in a lateral direction of the first joint member, and the second actuator may be disposed in a lateral direction of the second joint member. A rotation axis of the first actuator and a rotation axis of the first joint member may be spaced apart from each other, and a rotation axis of the second actuator and a rotation axis of the second joint member may also be spaced apart from each other. However, the embodiments are not limited thereto, and an actuator and a joint member may share a rotation axis. In an embodiment, each actuator may be spaced apart from a corresponding joint member. In this case, the driving module 35 or 45 may further include a power transmission module (not shown) configured to transmit power from the actuator to the joint member. The power transmission module may be a rotary body, such as a gear, or a longitudinal member, such as a wire, a cable, a string, a spring, a belt, or a chain. However, the scope of the embodiment is not limited by the positional relationship between an actuator and a joint member and the power transmission structure described above.

In an embodiment, when the wearable device 100 is worn on the legs of the user, the first torque transmission frame 55 and the second torque transmission frame 50 may transmit torque generated by the first driving module 45 and the second driving module 35 to the body (e.g., the legs) of the user, respectively. The transmitted torque may act as an external force applied to the motions of the legs of the user. Respective end portions of the first torque transmission frame 55 and the second torque transmission frame 50 may be directly or indirectly connected to the joint member and rotate. As the other end portions of the first torque transmission frame 55 and the second torque transmission frame 50 are directly or indirectly connected to the first thigh fastener 2 and the second thigh fastener 1, the first torque transmission frame 55 and the second torque transmission frame 50 may transmit the torque generated by the first driving module 45 and the second driving module 35 to the user's thighs while supporting the user's thighs. For example, the first torque transmission frame 55 and the second torque transmission frame 50 may push or pull the thighs of the user. The first torque transmission frame 55 and the second torque transmission frame 50 may extend in a longitudinal direction of the thighs of the user or may be bent and enclose at least some portions of the circumferences of the thighs of the user. The first torque transmission frame 55 may be a torque transmission frame for transmitting torque to the right leg of the user, and the second torque transmission frame 50 may be a torque transmission frame for transmitting torque to the left leg of the user.

The first thigh fastener 2 and the second thigh fastener 1 may be directly or indirectly connected to the first torque transmission frame 55 and the second torque transmission frame 50, respectively, and may fasten the wearable device 100 to the legs (specifically, thighs) of the user. The first thigh fastener 2 may be a thigh fastener for fastening the wearable device 100 to the right thigh of the user, and the second thigh fastener 1 may be a thigh fastener for fastening the wearable device 100 to the left thigh of the user.

In an embodiment, the first thigh fastener 2 may include a first cover, a first fastening frame, and a first strap, and the second thigh fastener 1 may include a second cover, a second fastening frame, and a second strap. The first cover and the second cover may apply torque generated by the first driving module 45 and the second driving module 35 to the thighs of the user, respectively. The first cover and the second cover may be disposed on respective sides of the thighs of the user and push or pull the thighs of the user, respectively. The first cover and the second cover may be arranged in circumferential directions of the thighs of the user. The first cover and the second cover may extend to both sides from the other end portions of the first torque transmission frame 55 and the second torque transmission frame 50, and may include curved surfaces corresponding to the thighs of the user. The respective ends of the first cover and the second cover may be directly or indirectly connected to the first fastening frame and the second fastening frame. The other ends of the first cover and the second cover may be directly or indirectly connected to the first strap and the second strap.

For example, the first fastening frame and the second fastening frame may be disposed to enclose at least some portions of the circumferences of the thighs of the user, thereby the thighs of the user may be prevented from being separated from the wearable device 100 or a possibility of separation may decrease. The first fastening frame may have a fastening structure that connects the first cover to the first strap, and the second fastening frame may have a fastening structure that connects the second cover to the second strap.

The first strap may enclose the remaining portion of the circumference of the right thigh of the user that is not covered by the first cover and the first fastening frame, and the second strap may enclose the remaining portion of the circumference of the left thigh of the user that is not covered by the second cover and the second fastening frame. The first strap and the second strap may include, for example, an elastic material (e.g., a band).

FIGS. 5A and 5B are diagrams illustrating components of a wearable device according to an embodiment.

Referring to FIG. 5A, the wearable device 100 may include a control module 510 (including control circuitry, such as processing circuitry), a communication module 516 including communication circuitry, a sensor module 520 including at least one sensor, a driving module 530, an input module including circuitry, and a sound output module 550 including a speaker. The driving module 530 may include a motor 534 configured to generate power (e.g., torque), and a motor driver circuit 532 to drive the motor 534. Although FIG. 5A illustrates the driving module 530 including one motor driver circuit 532 and one motor 534, the example of FIG. 5A is merely an example. Referring to FIG. 5B, in a control system 500-1, a plurality (two or more) of motor driver circuits 532 and 532-1 and a plurality (two or more) of motors 534 and 534-1 may be provided. The driving module 530 including the motor driver circuit 532 and the motor 534 may correspond to the first driving module 45 of FIG. 3, and a driving module 530-1 including the motor driver circuit 532-1 and the motor 534-1 may correspond to the second driving module 35 of FIG. 3. The following descriptions of the motor driver circuit 532 and the motor 534 may also be respectively applicable to the motor driver circuit 532-1 and the motor 534-1 illustrated in FIG. 5B.

The sensor module 520 may include at least one sensor configured to obtain sensor data. The sensor module 520 may transmit the obtained sensor data to the control module 510. The sensor module 520 may include an IMU 522, a first angle sensor 524, a second angle sensor 524-1, a pressure sensor 526, and/or a torque sensor 528 as shown in FIG. 5B. The IMU 522 may measure an upper body motion value of the user. For example, the IMU 522 may sense acceleration and angular velocity of an X-axis, a Y-axis, and a Z-axis according to a motion of the user. The upper body motion value of the user may correspond to a motion value of a waist support frame of the exercise assistance device. The first angle sensor 524 and the second angle sensor 524-1 may measure a hip joint angle according to the leg motion of the user. The first angle sensor 524 may sense the hip joint angle of the right leg of the user, and the second angle sensor 524-1 may sense the hip joint angle of the left leg of the user. The first angle sensor 524 and the second angle sensor 524-1 may include, for example, an encoder and/or a Hall sensor. The hip joint angle of the right leg sensed by the first angle sensor 524 may correspond to a motion value (e.g., a rotation angle value) of the first torque transmission frame 55 of the wearable device and the hip joint angle of the left leg sensed by the second angle sensor 524-1 may correspond to a motion value (e.g., a rotation angle value) of the second torque transmission frame 50 of the wearable device. The pressure sensor 526 may measure a pressure value applied to the pressure sensor 526. The pressure sensor 526 may measure a pressure value generated between the body of the user and the pressure sensor 526 when the user wears the wearable device 100. The pressure sensor 526 may include a first pressure sensor configured to output sensor data including a pressure value between a thigh fastener of the wearable device 100 and a leg of the user, and/or a second pressure sensor disposed at a position on the base body of the wearable device 100 facing the body of the user and configured to output sensor data including a pressure value between the base body and a lumbar region of the user. The first pressure sensor may be disposed on each of both thigh fasteners and may be disposed at a position on the thigh fastener facing the body of the user. The torque sensor 528 is disposed adjacent to the motors 534 and 534-1 and may measure a torque value applied to the torque sensor 528. In an embodiment, the sensor module 520 may further include a position sensor configured to obtain a position value of the wearable device 100, a proximity sensor configured to sense the proximity of an object, a biosignal sensor configured to detect a biosignal of the user, and/or a temperature sensor configured to measure an ambient temperature.

Referring back to FIG. 5A, an input module 540 may receive, from the outside (e.g., the user) of the wearable device, a command or data to be used for a component (e.g., the processor 512) of the wearable device. The input module 540 may include, for example, a key (e.g., a button), and/or a touch screen.

The sound output module 550 may output a sound signal to the outside of the wearable device. The sound output module 550 may include a guide sound signal (e.g., a driving start sound or an operation error notification sound) and a speaker for playing music content or a guide voice.

In an embodiment, the control system 500 may further include a battery (not shown) to supply power to each component of the wearable device. The wearable device may convert the power of the battery into power suitable for an operating voltage of each component of the wearable device and supply the converted power to each component.

The driving module 530 may generate an external force to be applied to a leg of the user under the control of the control module 510. The driving module 530 may be disposed in a position corresponding to a position of a hip joint of the user and may generate torque to be applied to a leg of the user, based on a control signal generated by the control module 510. The control module 510 may transmit the control signal to the motor driver circuit 532, and the motor driver circuit 532 may control an operation of the motor 534 by generating a current signal (or a voltage signal) corresponding to the control signal and supplying the current signal (or the voltage signal) to the motor 534. The current signal may not be supplied to the motor 534 according to the control signal. When the current signal is supplied to the motor 534, and the motor is driven, the motor 534 may generate an assistance force to assist leg motion of the user or a resistance force to impede the leg motion of the user.

The control module 510 may control an overall operation of the wearable device, and may generate a control signal to control each component of the wearable device. The control module 510 may include at least one processor 512 and a memory 514.

The processor 512 may execute, for example, software to control at least one other component (e.g., a hardware or software component) of the wearable device directly or indirectly connected to the processor 512, and perform a variety of data processing or computation. According to an embodiment, as at least a part of data processing or computation, the processor 512 may store instructions or data received from another component (e.g., the communication module 516) in the memory 514, may process the instructions or the data stored in the memory 514, and may store result data in the memory 514. The processor 512 may include at least one processor and operations of the processor 512 described herein may be performed by the at least one processor. According to an embodiment, the processor 512 may include a main processor (e.g., a central processing unit (CPU) or an application processor (AP)) or an auxiliary processor (e.g., a graphics processing unit (GPU), a neural processing unit (NPU), an image signal processor (ISP), a sensor hub processor, or a communication processor (CP)) that is operable independently from, or in conjunction with, the main processor. The auxiliary processor may be implemented separately from the main processor or as a part of the main processor. Thus, each “processor” herein comprises one or more processors, and comprises processing circuitry.

The memory 514 may store a variety of data used by at least one component (e.g., the processor 512) of the control module 510. The data may include, for example, software, sensor data, and input data or output data for instructions related thereto. The memory 514 may include a volatile memory or a non-volatile memory.

The communication module 516 may support establishing a direct (e.g., wired) communication channel or a wireless communication channel between the control module 510 and another component of the wearable device or an external electronic device (e.g., the electronic device 210 or the other wearable device 220 of FIG. 2), and performing communication via the established communication channel. For example, the communication module 516 may transmit the sensor data obtained by the sensor module 520 to an external electronic device (e.g., the electronic device 210 of FIG. 2) and receive a control signal from the external electronic device. The communication module 516 may include one or more CPs that are operable independently of the processor 512 and that support a direct (e.g., wired) communication or a wireless communication. According to an embodiment, the communication module 516 may include a wireless communication module (e.g., a cellular communication module, a short-range wireless communication module, or a global navigation satellite system (GNSS) communication module), and/or a wired communication module. The wireless communication module may communicate with another component of the wearable device 100 and/or an external device via, for example, Bluetooth TM, Wi-Fi, advanced and adaptive network technology (ANT) or infrared data association (IrDA), a legacy cellular network, a 5G network, a next-generation network, the Internet, or a computer network (e.g., a local area network (LAN) or a wide area network (WAN)).

The haptic module 560 may provide haptic feedback to the user under the control of the processor 512. The haptic module 560 may include one or a plurality of haptic actuators. The haptic actuator may include, for example, a piezo actuator, a bander type actuator, and/or a vibration motor-based actuator. One or a plurality of haptic actuators may be provided. In an embodiment, the haptic actuator may be disposed in at least one of a base body (e.g., the base body 80 of FIG. 3), a torque transmission frame (e.g., the first torque transmission frame 55 or the second torque transmission frame 50 of FIG. 3), and a thigh fastener (e.g., the first thigh fastener 2 or the second thigh fastener 1 of FIG. 3) of the wearable device 100.

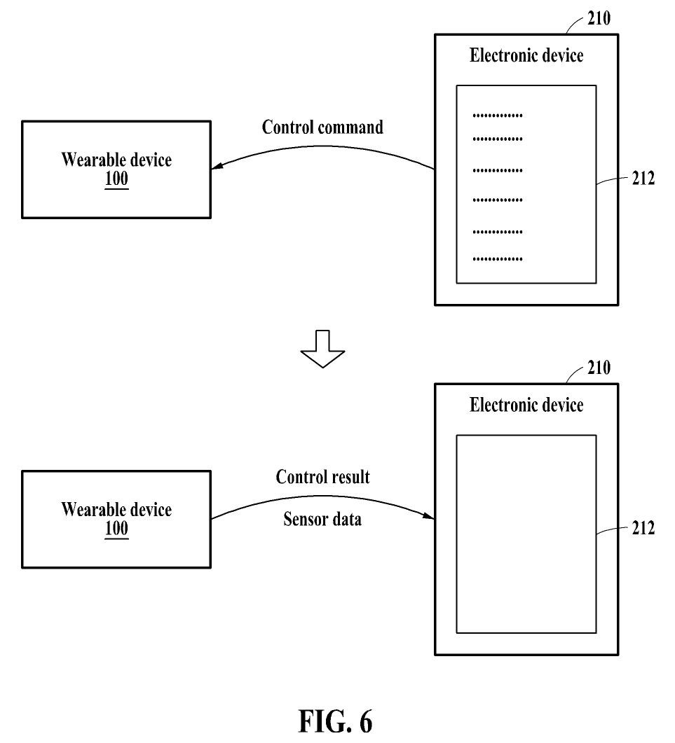

FIG. 6 is a diagram illustrating an interaction between a wearable device and an electronic device according to an embodiment.

Referring to FIG. 6, the wearable device 100 may communicate with the electronic device 210. For example, the electronic device 210 may be a user terminal of a user who uses the wearable device 100. In an embodiment, the wearable device 100 and the electronic device 210 may be connected to each other via short-range wireless communication (e.g., Bluetooth TM or Wi-Fi communication).

In an embodiment, the electronic device 210 may check a state of the wearable device 100 or execute an application to control or operate the wearable device 100. A screen of a UI may be displayed to control an operation of the wearable device 100 or determine an operating mode of the wearable device 100 on a display 212 of the electronic device 210 through the execution of the application. The UI may be, for example, a GUI.

In an embodiment, the user may input an instruction for controlling the operation of the wearable device 100 (e.g., an execution instruction to a walking assistance mode or an exercise assistance mode) or change settings of the wearable device 100 through a GUI screen on the display 212 of the electronic device 210. The electronic device 210 may generate a control command (or control signal) corresponding to an operation control command or a setting change command input by the user and transmit the generated control command to the wearable device 100. The wearable device 100 may operate according to the received control command and may transmit a control result according to the received control command and/or sensor data sensed by a sensor module of the wearable device 100 to the electronic device 210. The electronic device 210 may provide the user with result information (e.g., current exercise state information, exercise result information, exercise posture assessment information, and physical ability assessment information) derived by analyzing the control result and/or the sensor data through the GUI screen.

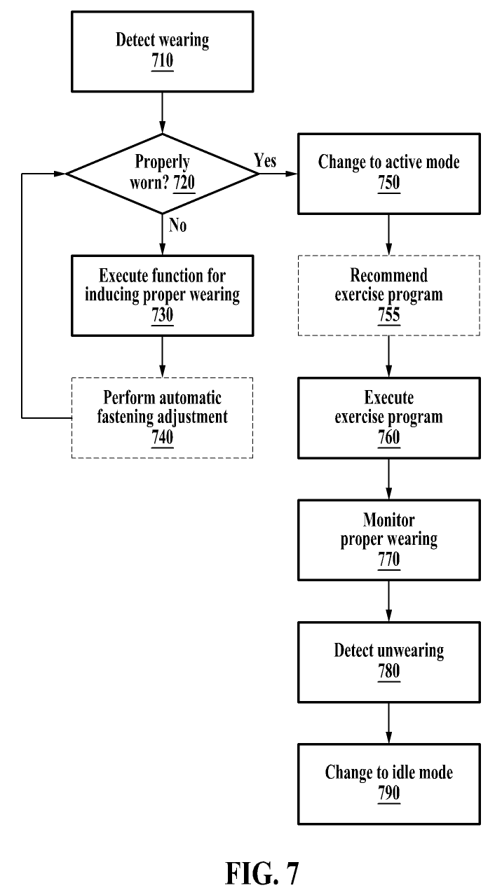

FIG. 7 is a diagram illustrating a wearing detection function of a wearable device according to an embodiment.

Referring to FIG. 7, in operation 710, a processor (e.g., the processor 512 of FIGS. 5A and 5B) of the wearable device 100 may detect wearing of the wearable device 100. Before wearing is detected, the wearable device 100 may operate in an idle mode. In the idle mode, torque generation by a driving module (e.g., the driving modules 530 and 530-1 of FIG. 5B) of the wearable device 100 is not allowed.

In an embodiment, when the wearable device 100 is disconnected from a charger that charges a battery of the wearable device 100, the processor may detect that the wearable device 100 is worn by a user when a pressure value is detected through a pressure sensor (e.g., the pressure sensor 526 of FIG. 5B) and/or when a torque value is detected through a torque sensor (e.g., the torque sensor 528 of FIG. 5B). When the processor detects that the wearable device 100 is disconnected from the charger, the processor may control a sound output module (e.g., the sound output module 550 of FIG. 5A) of the wearable device 100 to output a guide voice for inducing the user to wear the wearable device 100.

In operation 720,the processor may determine whether the wearable device 100 is properly worn by the user. For example, when an appropriate pressure value (e.g., a pressure value greater than a reference value set for each position) is measured at a position where one or more pressure sensors are disposed, the processor may determine that the wearable device 100 is properly worn by the user. If an appropriate pressure value is not measured at any one of positions where one or more pressure sensors are disposed, the processor may determine that the wearable device 100 is not properly worn by the user.

When it is determined that the wearable device 100 is not properly worn by the user (when determined as 'No' in operation 720), in operation 730, the processor may execute a function for inducing proper wearing of the wearable device 100. When a pressure value measured at a specific region is measured to be less than an appropriate pressure value before an exercise program using the wearable device 100 is executed, the processor may guide the user to re-wear the wearable device 100 through a guide voice and/or vibration feedback. For example, the processor may control the sound output module to output a guide voice for inducing proper wearing of the wearable device 100 or may control a haptic module (e.g., the haptic module 560 of FIG. 5A) to output vibration feedback.

In an embodiment, the wearable device 100 may include a first fastening adjuster configured to adjust a degree of fastening of a thigh fastener (e.g., the thigh fasteners 1 and 2 of FIG. 3) and/or a second fastening adjuster configured to adjust a degree of fastening of a waist fastener (e.g., the waist fastener 60 of FIG. 3). In this case, in operation 740, the processor may control a degree of tightening of the first fastening adjuster and/or the second fastening adjuster based on a pressure value measured by the pressure sensor. The processor may adjust pressure between the wearable device 100 and the body of the user due to fastening of the thigh fastener and/or the waist fastener to an appropriate pressure through automatic fastening adjustment. The processor may control a degree of tightening of the first fastening adjuster such that a pressure value measured by the first pressure sensor configured to measure a pressure value between the thigh fastener and the leg of the user becomes an appropriate pressure value. The processor may control a degree of tightening of the second fastening adjuster such that a pressure value measured by the second pressure sensor configured to measure a pressure value between the base body (e.g., the base body 80 of FIG. 3) and the lumbar region of the user becomes an appropriate pressure value. The first fastening adjuster and the second fastening adjuster may be implemented in various manners. For example, a degree of tightening of the first fastening adjuster and the second fastening adjuster may be adjusted through a pneumatic method of adjusting a degree of tightening by adjusting air pressure or a motor-wire method of adjusting a degree of tightening of a wire through motor control.

Depending on the embodiment, operation 740 may be selectively performed. When the wearable device 100 does not include the first fastening adjuster and/or the second fastening adjuster or when an automatic fastening adjustment function is deactivated by user selection, operation 740 may not be performed. When the wearable device 100 includes the first fastening adjuster and/or the second fastening adjuster or when the automatic fastening adjustment function is activated by user selection, operation 740 may be automatically performed.

When it is determined that the wearable device 100 is properly worn by the user (when determined as 'Yes' in operation 720), in operation 750, the processor may change an operating mode of the wearable device 100 to an active mode. The active mode refers to a mode in which torque generation from the driving module of the wearable device 100 becomes possible by a start of an exercise program or a user command. The wearable device 100 may operate in the idle mode until the operating mode is changed to the active mode. The active mode may also be referred to as a 'wakeup mode'.

In operation 755, the processor may recommend an exercise program to the user. For example, the processor may recommend an exercise program scheduled to be performed by the user or may recommend an exercise program based on a previously performed exercise program. For example, assuming that the user has performed an exercise program of 'power walking' previously or an exercise program of 'power walking' is scheduled to be performed today according to an exercise schedule, the processor may control the sound output module to output a guide voice such as 'How about a power walking exercise today?'. A guide voice for recommending an exercise program may be output through not only the wearable device 100 but also an electronic device (e.g., the electronic device 210 of FIG. 2) and/or another wearable device (e.g., the other wearable device 220 of FIG. 2). Depending on the embodiment, operation 755 may be selectively performed.

In operation 760, the processor may execute an exercise program selected by the user or may automatically execute an exercise program. For example, when the user selects an exercise program through a smartwatch (e.g., the smartwatch 224 of FIG. 2), the processor may drive the wearable device 100 based on the exercise program selected by the user. When it is detected that the user has started a movement for exercise without a process of selecting an exercise program, the processor may estimate an exercise program that the user intends to perform and may automatically execute the estimated exercise program. For example, when the user starts an exercise movement of 'power walking' in a state where the user has not selected an exercise program, the processor may detect a movement of the user through an IMU (e.g., the IMU 522 of FIG. 5B), an angle sensor (e.g., the first angle sensor 524 and the second angle sensor 524-1 of FIG. 5B), and/or a torque sensor (e.g., the torque sensor 528 of FIG. 5B). The processor may estimate that an exercise program that the user intends to perform is 'power walking' based on a result of analyzing the movement of the user and may switch a state of the wearable device 100 to a start state of the exercise program of 'power walking'. By automatically executing an exercise program by analyzing a movement of the user, processes required for selecting an exercise program before a start of the exercise program may be omitted, and thus user convenience for the wearable device 100 may be improved. From a user's perspective, the user may pick up and wear the wearable device 100 and then immediately start an exercise motion to start an exercise program, and thus user convenience may be improved.

After the exercise program is executed, in operation 770, the processor may continuously monitor whether the wearable device 100 is properly worn. A wearing state of the wearable device 100 may change due to movement of the user, contraction and expansion of muscles, and the like, according to progress of the exercise program. The processor may continuously check whether the wearable device 100 is properly worn not only when the wearable device 100 is initially worn by the user but also while the user wears the wearable device 100 and exercises. The processor may automatically monitor the wearing state of the wearable device 100 based on at least one of a pressure value measured by a pressure sensor (e.g., the first pressure sensor or the second pressure sensor) and a torque value measured by a torque sensor in the active mode of the wearable device 100. The processor may perform control to output at least one of vibration feedback and a guide voice for inducing proper wearing of the wearable device 100 in at least one of a case in which a pressure value measured by the pressure sensor is equal to or less than a first reference value and a case in which a torque value measured by the torque sensor is equal to or less than a second reference value.

In an embodiment, when it is determined that the wearing state of the wearable device 100 is not a proper wearing state while an exercise program is in progress in a state where the automatic fastening adjustment function is activated, the processor may automatically adjust a tightening state of the thigh fastener and/or the waist fastener through the first fastening adjuster and/or the second fastening adjuster. For example, the processor may control a degree of tightening of the first fastening adjuster such that a pressure value measured by the first pressure sensor becomes an appropriate pressure value and may control a degree of tightening of the second fastening adjuster such that a pressure value measured by the second pressure sensor becomes an appropriate pressure value.

In operation 780, the processor may detect unwearing of the wearable device 100. For example, when the exercise program is stopped or terminated, when the wearable device 100 is connected to the charger, or when the pressure value measured by the pressure sensor corresponds to a pressure value measured in an unworn state of the wearable device 100, the processor may determine that the wearable device 100 is unworn or is highly likely to be unworn. In an embodiment, the user may change a mode of the wearable device 100 to the idle mode by loosening the thigh fastener or the waist fastener without taking a motion while wearing the wearable device 100, without having to perform a specific operation or user input to make the wearable device 100 recognize that the user intends to unwear the wearable device 100. When a motion of the user is not detected by analyzing sensor data measured by the IMU and/or the angle sensor in the active mode of the wearable device 100 and the pressure value measured by the pressure sensor is less than a specific reference value, the processor may determine that the wearable device 100 is unworn or the user intends to unwear the wearable device 100.

When unwearing is detected, in operation 790, the processor may change the wearable device 100 to the idle mode. When the wearable device 100 is changed to the idle mode, if it is detected that the wearable device 100 is connected to the charger after proper wearing of the wearable device 100 is changed to the idle mode again, the processor may change the wearable device 100 to a charging mode, which is a mode in which the battery of the wearable device 100 is charged.

Due to characteristics of the wearable device 100 being worn on the body of the user and applying an external force to the body of the user, proper wearing and accurate wearing of the wearable device 100 are important in terms of safety and usability. The processor may guide the user on a current wearing state of the wearable device 100 and induce proper wearing of the wearable device 100 when the user initially wears the wearable device 100 and when a wearing state changes such as when the thigh fastener and/or the waist fastener becomes loose during performance of an exercise program. In addition, the processor may automatically and appropriately adjust a degree of tightening of the thigh fastener and/or the waist fastener by controlling the first fastening adjuster and/or the second fastening adjuster. Through such an automatic fastening adjustment function, the user may maintain an optimal exercise experience while an exercise program is in progress. In addition, the processor may reduce user intervention (e.g., a separate test process for checking whether proper wearing is achieved) and required steps (e.g., a step of receiving user input for selection of an exercise program) required for use of the wearable device 100, thereby improving user convenience.

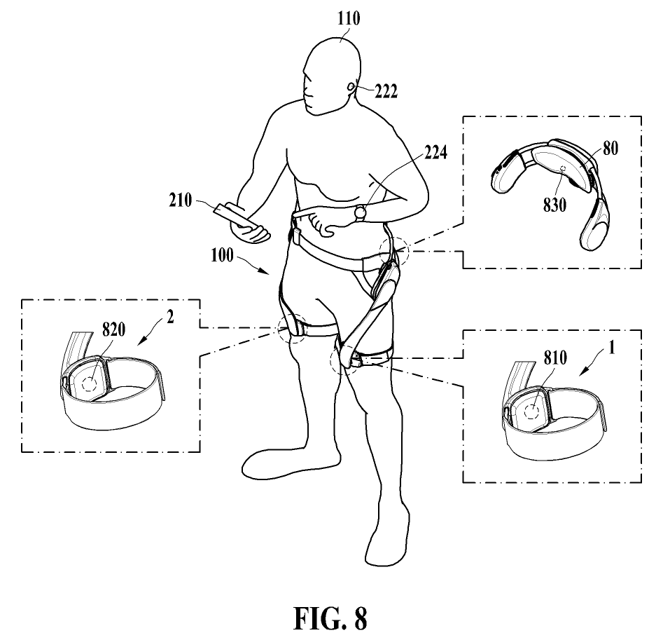

FIG. 8 is a diagram illustrating an arrangement of a pressure sensor in a wearable device according to an embodiment.

Referring to FIG. 8, the wearable device 100 may include pressure sensors 810, 820, and 830 for measuring a pressure value between the body of the user 110 and the wearable device 100 at one or more positions. The pressure sensors 810, 820, and 830 may be disposed at regions that receive a large amount of pressure among regions where the wearable device 100 is worn on the body of the user 110 and that need to maintain a certain level or more of pressure during driving of the wearable device 100. The pressure sensors 810, 820, and 830 may measure a pressure value in real time, and the measured pressure value may be transmitted to a processor (e.g., the processor 512 of FIGS. 5A and 5B) of the wearable device 100. The pressure sensors 810, 820, and 830 may be replaced with a 'force sensor' configured to measure an applied force and may include, for example, a strain gauge, which is a sensor whose resistance changes according to applied pressure (or force). The processor may measure a magnitude of a pressure value generated by the wearable device 100 being worn on the body of the user 110, through the pressure sensors 810, 820, and 830.

In an embodiment, the wearable device 100 may include a first pressure sensor 810 or 820 configured to output sensor data including a pressure value between the thigh fasteners 1 and 2 and a leg of the user 110, and/or a second pressure sensor 830 configured to output sensor data including a pressure value between the base body 80 and a lumbar region of the user 110. In an embodiment, the first pressure sensor 820 is disposed at a position on the first thigh fastener 2 facing the body of the user 110, and the first pressure sensor 810 may be disposed at a position on the second thigh fastener 1 facing the body of the user 110. For example, the first pressure sensor 820 is disposed on an inner side of a first cover, which is a relatively rigid component, in the first thigh fastener 2, and the first pressure sensor 810 may be disposed on an inner side of a second cover, which is a relatively rigid component, in the second thigh fastener 1. The second pressure sensor 830 may be disposed on an inner side of the base body 80, which is a position on the base body 80 facing the body of the user 110.

In an embodiment, the first pressure sensors 810 and 820 are supplied with power through a battery embedded in the base body 80 or a separate battery and may transmit the measured pressure value to a control system (e.g., the control system 500 of FIG. 5A or the control system 500-1 of FIG. 5B) of the wearable device 100 through wireless communication (e.g., Bluetooth communication) or wired communication. The second pressure sensor 830 may be supplied with power through a battery embedded in the base body 80 and may transmit to the control system of the wearable device 100 through wired communication.

The processor may determine whether the wearable device 100 is properly worn, based on a pressure value measured by the first pressure sensors 810 and 820 and/or the second pressure sensor 830. When it is determined that the wearable device 100 is not properly worn by the user, the processor may control such that a notification or a guide voice for inducing proper wearing of the wearable device 100 to the user is output through the wearable device 100, the electronic device 210, the smartwatch 224, and/or the wireless earphones 222.

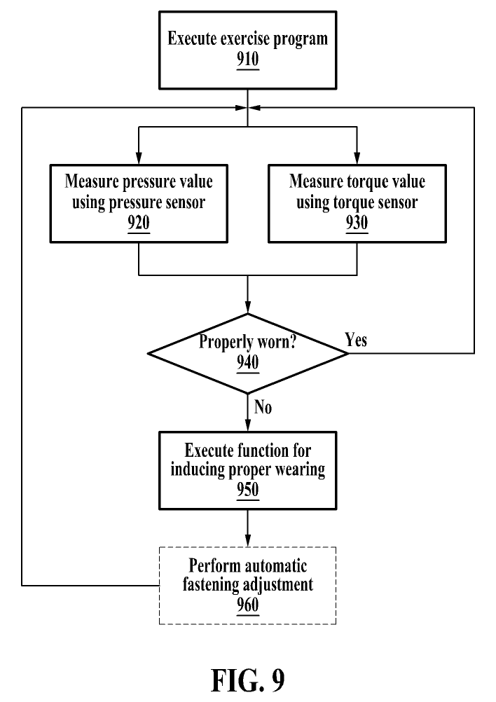

FIG. 9 is a diagram illustrating a proper wearing monitoring function of a wearable device after a start of an exercise program according to an embodiment.

Referring to FIG. 9, in operation 910, a processor (e.g., the processor 512 of FIGS. 5A and 5B) of the wearable device 100 may execute an exercise program. The processor may continuously monitor proper wearing of the wearable device 100 after the exercise program is started.

In operation 920, the processor may measure a pressure value in real time using a pressure sensor (e.g., the pressure sensor 526 of FIG. 5B) while the exercise program is being performed. For example, the processor may measure a pressure value between the thigh fastener and a thigh of the user using a first pressure sensor (e.g., the first pressure sensors 810 and 820 of FIG. 8) disposed at a thigh fastener (e.g., the thigh fasteners 1 and 2 of FIG. 3) of the wearable device 100. The processor may measure a pressure value between the base body and a lumbar region of the user using a second pressure sensor (e.g., the second pressure sensor 830 of FIG. 8) disposed at a base body (e.g., the base body 80 of FIG. 3) of the wearable device 100.

In operation 930, the processor may measure a torque value in real time using a torque sensor (e.g., the torque sensor 528 of FIG. 5B) while the exercise program is being performed. The torque sensor may measure torque (or force) generated by a leg motion of the user.

In operation 940, the processor may determine whether the wearable device 100 is properly worn, based on a pressure value measured by the pressure sensor and/or a torque value measured using the torque sensor. For example, the processor may determine that the wearable device 100 is not properly worn in at least one of a case in which the measured pressure value is equal to or less than a first reference value and a case in which the torque value is equal to or less than a second reference value. Alternatively, the processor may determine that the wearable device 100 is not properly worn when the measured pressure value is equal to or less than the first reference value and the measured torque value is equal to or less than the second reference value. The processor may determine that the wearable device 100 is properly worn when the measured pressure value is greater than the first reference value and the measured torque value is greater than the second reference value. In an embodiment, when the torque value is not considered in determining whether proper wearing is achieved, it may be determined that the wearable device 100 is properly worn when a pressure value measured by the pressure sensor is greater than the first reference value.

When it is determined that the wearable device 100 is properly worn (when determined as 'Yes' in operation 940), the processor may perform operation 920 and operation 930 again and may continuously monitor whether the wearable device 100 is properly worn, based on the measured pressure value and/or torque value.

When it is determined that the wearable device 100 is not properly worn (when determined as 'No' in operation 940), in operation 950, the processor may execute a function for inducing proper wearing of the wearable device 100. For example, the processor may perform control to output at least one of vibration feedback and a guide voice for inducing proper wearing of the wearable device 100. The guide voice may include a message warning that the wearable device 100 is currently not properly worn on the body of the user and/or a message requesting to check a fastening state of the thigh fastener and the waist fastener.

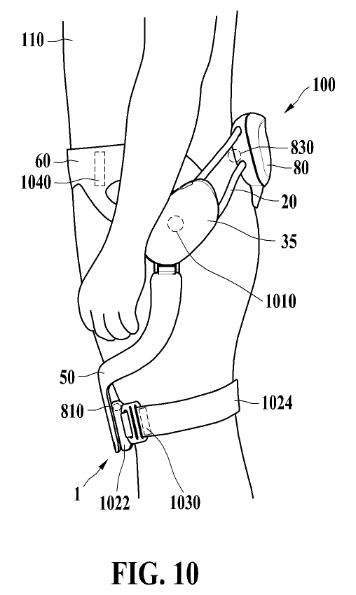

When the wearable device 100 supports an automatic fastening adjustment function, in operation 960, the processor may perform the automatic fastening adjustment function through a fastening adjuster. The fastening adjuster may include a first fastening adjuster (e.g., the first fastening adjuster 1030 of FIG. 10) configured to adjust a degree of fastening of the thigh fastener and/or a second fastening adjuster (e.g., the second fastening adjuster 1040 of FIG. 10) configured to adjust a degree of fastening of the waist fastener. The processor may control a degree of tightening of the first fastening adjuster and/or the second fastening adjuster such that a pressure value measured by the pressure sensor becomes an appropriate pressure value. In most cases, a fastening strength of the thigh fastener and/or the waist fastener may become loose during exercise, and in this case, a pressure value measured by the pressure sensor will become smaller than the pressure value measured before the start of the exercise. When such a decrease in the pressure value exceeds an appropriate level, the processor may increase the fastening strength of the thigh fastener and/or the waist fastener by controlling the degree of tightening of the first fastening adjuster and/or the second fastening adjuster.

After an automatic fastening adjustment process is completed, the processor may perform operation 920 and operation 930 again. The processor may continuously monitor whether the wearable device 100 is properly worn, based on the measured pressure value and/or torque value.

FIG. 10 is a diagram illustrating operations of a pressure sensor and a fastening adjuster of a wearable device according to an embodiment.

Referring to FIG. 10, a side view of the user 110 wearing the wearable device 100 is illustrated. The wearable device 100 may include a pressure sensor configured to measure a pressure value at one or more positions. In an embodiment, a first pressure sensor 810 may be disposed on an inner side of a second thigh fastener 1 worn on a left leg of the user 110. The first pressure sensor 810 may measure a pressure value between the left leg and the second thigh fastener 1. Although not illustrated in the drawing, a first pressure sensor (e.g., the first pressure sensor 820 of FIG. 8) configured to measure a pressure value between a right leg and a first thigh fastener may be disposed on an inner side of the first thigh fastener (e.g., the first thigh fastener 2 of FIG. 3) worn on the right leg of the user 110. A second pressure sensor 830 configured to measure a pressure value between the base body 80 and a lumbar region of the user 110 may be disposed on an inner side of the base body 80.

In an embodiment, the wearable device 100 may include a torque sensor configured to measure a torque value generated by a motor of the driving module. In the drawing, a torque sensor 1010 included in a second driving module 35 (e.g., the driving module 530-1 of FIG. 5B) is illustrated. The torque sensor 1010 may measure a torque value generated by a motor (e.g., the motor 534-1 of FIG. 5B) of the second driving module 35, which is affected by a motion of the left leg of the user 110.

The wearable device 100 may include a fastening adjuster configured to adjust a fastening state of the wearable device 100. For example, the wearable device 100 may include a first fastening adjuster 1030 configured to adjust a degree of fastening of the first thigh fastener 2 and/or a second fastening adjuster 1040 configured to adjust a degree of fastening of the waist fastener 60. Although not illustrated in the drawing, the wearable device 100 may further include a first fastening adjuster (not shown) configured to adjust a degree of fastening of the second thigh fastener.

In an embodiment, the first fastening adjuster 1030 and the second fastening adjuster 1040 may be a manual type in which a degree of tightening is manually adjusted by a user's manipulation such as Velcro or a buckle, or may be an automatic type in which a degree of tightening is automatically adjusted by a processor (e.g., the processor 512 of FIGS. 5A and 5B) of the wearable device 100. When the first fastening adjuster 1030 and the second fastening adjuster 1040 are the automatic type, a degree of tightening of the first fastening adjuster 1030 and the second fastening adjuster 1040 may be adjusted through a pneumatic method of adjusting a degree of tightening by adjusting air pressure or a motor-wire method of adjusting a degree of tightening of a wire through motor control. In the case of the motor-wire method, the motor-wire method may include a dial, a gear, and a wire whose rotation is controlled by a motor, and the wire may be tightened or loosened through the gear connected to the dial when the dial is rotated by the motor.

When the user 110 performs exercise after wearing the wearable device 100, a fastening strength of the waist fastener 60 and/or the second thigh fastener 1 may become loose, and a phenomenon in which the waist fastener 60 and/or the second thigh fastener 1 slides down from an initial wearing position may occur. When a wearing state of the wearable device 100 is not proper (or is not correct), a gap may occur at a front side or a rear side of the second thigh fastener 1. When the gap occurs, a pressure value measured by the first pressure sensor 810 will be measured differently from a pressure value measured at an initial stage of wearing the wearable device 100, and the processor may detect that the wearing state of the wearable device 100 is not proper, through such a change in the pressure value. In addition, when the gap occurs, a loss of torque (or force) may occur in a process in which a force generated by a leg motion of the user 110 is transmitted to the torque sensor 1010 through a second torque transmission frame 50. When a loss of torque occurs, a torque value measured by the torque sensor 1010 will be measured differently from a torque value measured at the initial stage of wearing the wearable device 100, and the processor may detect that the wearing state of the wearable device 100 is not proper, through such a change in the torque value.

In an embodiment, when it is determined that a wearing state of the wearable device 100 is not proper, the processor may automatically adjust the degree of tightening of the first fastening adjuster 1030 and/or the second fastening adjuster 1040 to change to a proper wearing state.

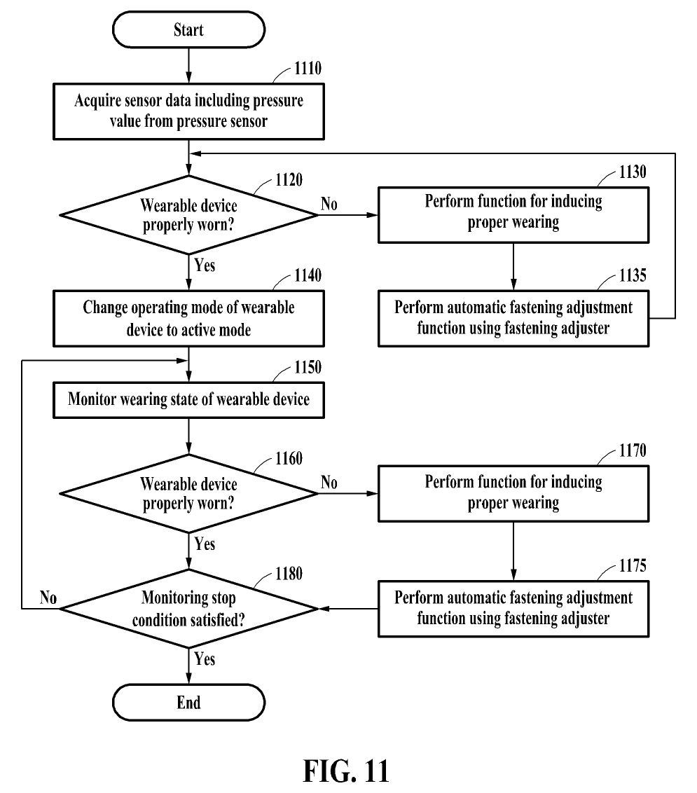

FIG. 11 is a flowchart illustrating operations of a control method of a wearable device performing wearing detection function according to an embodiment. In an embodiment, at least one of operations of FIG. 11 may be performed simultaneously or in parallel with another operation, and the order of the operations may be changed. In addition, at least one of the operations may be omitted, or another operation may be additionally performed.

Referring to FIG. 11, in operation 1110, a processor (e.g., the processor 512 of FIGS. 5A and 5B) may acquire sensor data including a pressure value from a pressure sensor (e.g., the pressure sensor 526 of FIG. 5B). In an embodiment, the processor may acquire sensor data including a pressure value between a thigh fastener (e.g., the thigh fasteners 1 and 2 of FIG. 3) of the wearable device 100 and a leg of the user from a first pressure sensor (e.g., the first pressure sensors 810 and 820 of FIG. 8). The processor may measure a pressure value between a base body (e.g., the base body 80 of FIG. 3) and a lumbar region of the user using a second pressure sensor (e.g., the second pressure sensor 830 of FIG. 8).

In operation 1120, the processor may determine, based on the sensor data, whether the wearable device 100 is properly worn by the user. In an embodiment, the processor may determine that the wearable device 100 is properly worn by the user when a pressure value measured by the first pressure sensor is greater than a reference value. When the wearable device 100 includes a plurality of first pressure sensors located at different positions of the wearable device 100, the processor may determine that the wearable device 100 is properly worn by the user when each pressure value measured by each of the first pressure sensors is greater than a reference value. When a pressure value measured by the first pressure sensor is equal to or less than the reference value, the processor may determine that the wearable device 100 is not properly worn by the user.

In an embodiment, the processor may acquire sensor data including a pressure value between the base body of the wearable device 100 and the lumbar region of the user from the second pressure sensor and may determine whether the wearable device 100 is properly worn by the user, based on the pressure value between the base body and the lumbar region of the user. The processor may determine that the wearable device 100 is properly worn by the user when a pressure value measured by the second pressure sensor is greater than a reference value. When a pressure value measured by the second pressure sensor is equal to or less than the reference value, the processor may determine that the wearable device 100 is not properly worn by the user.

In an embodiment, the processor may determine that the wearable device 100 is properly worn by the user when a pressure value measured by the first pressure sensor is greater than a first reference value and a pressure value measured by the second pressure sensor is greater than a second reference value. When a pressure value measured by the first pressure sensor is equal to or less than the first reference value or a pressure value measured by the second pressure sensor is equal to or less than the second reference value, the processor may determine that the wearable device 100 is not properly worn by the user.

In response to a determination that the wearable device 100 is not properly worn by the user (when determined as 'No' in operation 1120), in operation 1130, the processor may perform an inducing function for inducing proper wearing of the wearable device 100. For example, the processor may perform control to output at least one of vibration feedback and a guide voice for inducing proper wearing of the wearable device 100.

In an embodiment, the wearable device 100 may include a fastening adjuster configured to adjust a fastening state of the wearable device 100. For example, the wearable device 100 may further include at least one of a first fastening adjuster (e.g., the first fastening adjuster 1030 of FIG. 10) located at a thigh fastener of the wearable device 100 and a second fastening adjuster (e.g., the second fastening adjuster 1040 of FIG. 10) located at a waist fastener of the wearable device 100. When the wearable device 100 includes the fastening adjuster, in operation 1135, the processor may perform an automatic fastening adjustment function using the fastening adjuster. The processor may control a degree of tightening of at least one of the first fastening adjuster and the second fastening adjuster based on a pressure value measured by one or more pressure sensors included in the wearable device. For example, the processor may control a degree of tightening of the first fastening adjuster such that a pressure value measured by the first pressure sensor becomes an appropriate pressure value and may control a degree of tightening of the second fastening adjuster such that a pressure value measured by the second pressure sensor becomes an appropriate pressure value.

In response to a determination that the wearable device 100 is properly worn by the user (when determined as 'Yes' in operation 1120), in operation 1140, the processor may change an operating mode of the wearable device 100 to an active mode.

In operation 1150, the processor may continuously monitor a wearing state of the wearable device 100. In the active mode of the wearable device 100, the processor may monitor the wearing state of the wearable device 100 based on at least one of a pressure value measured by the first pressure sensor and a torque value measured by a torque sensor included in the wearable device 100. In addition, the processor may determine whether the wearable device is properly worn by the user, based on a pressure value between the base body and the lumbar region of the user measured by the second pressure sensor.

In operation 1160, the processor may determine, based on the sensor data, whether the wearable device 100 is properly worn by the user. A criterion for determining whether proper wearing is achieved in operation 1160 is the same as that described in operation 1120, and a redundant description thereof will be omitted.

In response to a determination that the wearable device 100 is not properly worn by the user (when determined as 'No' in operation 1160), in operation 1170, the processor may perform an inducing function for inducing proper wearing of the wearable device 100. In the active mode of the wearable device 100, it may be determined that the wearable device 100 is not properly worn by the user in at least one of a case in which a pressure value measured by the first pressure sensor is equal to or less than a first reference value and a case in which a torque value measured by the torque sensor is equal to or less than a second reference value, and in this case, the processor may perform control to output at least one of vibration feedback and a guide voice for inducing proper wearing of the wearable device 100.

When the wearable device 100 includes the fastening adjuster, in operation 1175, the processor may perform the automatic fastening adjustment function using the fastening adjuster. The processor may control a degree of tightening of at least one of the first fastening adjuster and the second fastening adjuster based on a pressure value measured by one or more pressure sensors included in the wearable device 100.

When it is determined that the wearable device 100 is properly worn as a result of determination in operation 1160 (when determined as 'Yes' in operation 1160), in operation 1180, the processor may determine whether a monitoring stop condition, which is a condition for stopping monitoring of a proper wearing state of the wearable device 100, is satisfied. For example, when the exercise program is stopped or terminated, when the wearable device 100 is connected to a charger, or when unwearing of the wearable device 100 is detected, it may be determined that the monitoring stop condition is satisfied. When the monitoring stop condition is satisfied (when determined as 'Yes' in operation 1180), the processor may stop driving the wearable device 100 and switch the wearable device 100 to the idle mode. When the monitoring stop condition is not satisfied (when determined as 'No' in operation 1180), the processor may return to operation 1150 to continue to monitor the wearing state of the wearable device 100.

A wearable device 100, according to an embodiment, may include a driving module (e.g., the driving modules 530 and 530-1 of FIG. 5B) including a motor (e.g., the motors 534 and 534-1 of FIG. 5B) configured to generate torque, a torque transmission frame (e.g., the torque transmission frames 50 and 55 of FIG. 3) configured to transmit the generated torque to a leg of a user, a thigh fastener (e.g., the thigh fasteners 1 and 2 of FIG. 3) connected to the torque transmission frame and configured to connect the torque transmission frame to the leg of the user, a first pressure sensor (e.g., the first pressure sensors 810 and 820 of FIG. 8) configured to output sensor data including a pressure value between the thigh fastener and the leg of the user, and one or more processors (e.g., the processor 512 of FIG. 5B). The first pressure sensor may be disposed at a position on the thigh fastener facing the body of the user.

In an embodiment, the one or more processors may acquire sensor data from the first pressure sensor and may determine, based on the sensor data, whether the wearable device 100 is properly worn by the user. The one or more processors may determine that the wearable device 100 (in particular, the thigh fastener of the wearable device 100) is properly worn by the user when a pressure value measured by the first pressure sensor is greater than a reference value. The one or more processors may change an operating mode of the wearable device 100 to an active mode in response to a determination that the wearable device 100 is properly worn by the user. The one or more processors may determine that the wearable device 100 is not properly worn by the user when a pressure value measured by the first pressure sensor is equal to or less than the reference value. The one or more processors may perform control to output at least one of vibration feedback and a guide voice for inducing proper wearing of the wearable device 100 in response to a determination that the wearable device 100 is not properly worn by the user.

In an embodiment, in the active mode of the wearable device 100, the one or more processors may monitor a wearing state of the wearable device 100 based on at least one of a pressure value measured by the first pressure sensor and a torque value measured by a torque sensor (e.g., the torque sensor 528 of FIG. 5B) included in the wearable device 100. In the active mode of the wearable device 100, the one or more processors may perform control to output at least one of vibration feedback and a guide voice for inducing proper wearing of the wearable device 100 in at least one of a case in which a pressure value measured by the first pressure sensor is equal to or less than a first reference value and a case in which a torque value measured by the torque sensor is equal to or less than a second reference value.

In an embodiment, the wearable device 100 may further include a base body (e.g., the base body 80 of FIG. 3) configured to support a lumbar region of the user and a second pressure sensor (e.g., the second pressure sensor 830 of FIG. 8) disposed at a position on the base body facing the body of the user and configured to output sensor data including a pressure value between the base body and the lumbar region of the user. The one or more processors may determine whether the wearable device 100 is properly worn by the user, based on a pressure value measured by the second pressure sensor. The one or more processors may determine that the wearable device 100 (in particular, the waist fastener of the wearable device 100) is properly worn by the user when a pressure value measured by the second pressure sensor is greater than a reference value. The one or more processors may determine that the wearable device 100 is not properly worn by the user when a pressure value measured by the second pressure sensor is equal to or less than the reference value.

In an embodiment, the wearable device 100 may further include at least one of a first fastening adjuster (e.g., the first fastening adjuster 1030 of FIG. 10) located at a thigh fastener of the wearable device and a second fastening adjuster (e.g., the second fastening adjuster 1040 of FIG. 10) located at a waist fastener (e.g., the waist fastener 60 of FIGS. 3 and 4) of the wearable device 100. The one or more processors may control a degree of tightening of the first fastening adjuster based on a pressure value measured by the first pressure sensor. The one or more processors may control a degree of tightening of the second fastening adjuster based on a pressure value measured by the second pressure sensor.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, "A or B", "at least one of A and B", "at least one of A or B", "A, B or C", "at least one of A, B and C", and "at least one of A, B, or C," each of which may include any one of the items listed together in the corresponding one of the phrases, or all possible combinations thereof. Terms such as "1st" and "2nd," or "first" and "second" may be used to simply distinguish a corresponding component from other components, and do not limit the components in other aspects (e.g., importance or order). It is to be understood that if a component (e.g., a first component) is referred to, with or without the term "operatively" or "communicatively," as "coupled with," "coupled to," "connected with," or "connected to" another component (e.g., a second component), the component may be coupled with the other component directly (e.g., wiredly), wirelessly, or via at least third component(s).

As used in connection with various embodiments of the disclosure, the term "module" may include a unit implemented in hardware, software, or firmware, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuit (ASIC). Accordingly, each "module" in the present disclosure may include a circuit.

The software may include a computer program, a piece of code, an instruction, or one or more combinations thereof, to independently or collectively instruct or configure the processing device to operate as desired. Software and/or data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording media. Embodiments as set forth herein may be implemented as software including one or more instructions that are stored in a storage medium that is readable by a machine. For example, a processor of the machine may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to embodiments may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore^{TM}), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

Although the present disclosure exemplifies and describes with reference to various embodiments, it shall be construed that various embodiments are for the illustrative purpose rather than limiting. It shall be further understood by those skilled in the art that various changes in forms and details may be made without departing from the true spirit and full scope of this disclosure including the scope of the attached claims and their equivalents. In addition, it shall be construed that the embodiments described herein may be used with other embodiments of the present disclosure.

1. A wearable device comprising:
a driving module, comprising a motor, configured to generate torque;
a torque transmission frame configured to transmit the generated torque to a leg of a user;
a thigh fastener connected to the torque transmission frame and configured to connect the torque transmission frame to the leg of the user;
a first pressure sensor configured to output sensor data including a pressure value between the thigh fastener and the leg of the user; and
one or more processors comprising processing circuitry, wherein the one or more processors is/are individually and/or collectively configured to:
acquire the sensor data from the first pressure sensor,
determine, based on the sensor data, whether the wearable device is properly worn by the user, and
change an operating mode of the wearable device to an active mode in response to a determination that the wearable device is properly worn by the user.

2. The wearable device of claim 1, wherein the one or more processors is/are individually and/or collectively configured to:
determine that the wearable device is properly worn by the user when the pressure value measured by the first pressure sensor is greater than a reference value.

3. The wearable device of claim 1, wherein the one or more processors is/are individually and/or collectively configured to:
determine that the wearable device is not properly worn by the user when the pressure value measured by the first pressure sensor is less than or equal to the reference value.

4. The wearable device of claim 3, wherein the one or more processors is/are individually and/or collectively configured to perform control to output at least one of vibration feedback and a guide voice for inducing proper wearing of the wearable device in response to a determination that the wearable device is not properly worn by the user.

5. The wearable device of claim 1, wherein the one or more processors is/are individually and/or collectively configured to, in the active mode, monitor a wearing state of the wearable device based on at least one of the pressure value measured by the first pressure sensor and a torque value measured by a torque sensor included in the wearable device.

6. The wearable device of claim 5, wherein the one or more processors is/are individually and/or collectively configured to, in the active mode, perform control to output at least one of vibration feedback and a guide voice for inducing proper wearing of the wearable device in at least one of a case in which the pressure value measured by the first pressure sensor is less than or equal to a first reference value and a case in which the torque value measured by the torque sensor is less than or equal to a second reference value.

7. The wearable device of claim 1, wherein the first pressure sensor is configured to be disposed at a position in the thigh fastener facing a body of the user.

8. The wearable device of claim 1, further comprising:
a base body configured to support a lumbar region of the user; and
a second pressure sensor configured to be disposed at a position in the base body facing the body of the user and configured to output sensor data including a pressure value between the base body and the lumbar region of the user.

9. The wearable device of claim 8, wherein the one or more processors is/are individually and/or collectively configured to determine whether the wearable device is properly worn by the user, based on the pressure value measured by the second pressure sensor.

10. The wearable device of claim 8, further comprising at least one of a first fastening adjuster configured to be located at the thigh fastener of the wearable device and a second fastening adjuster configured to be located at a waist fastener of the wearable device,
wherein the one or more processors is/are individually and/or collectively configured to control a degree of tightening of the first fastening adjuster based on the pressure value measured by the first pressure sensor, and control a degree of tightening of the second fastening adjuster based on the pressure value measured by the second pressure sensor.

11. A control method of a wearable device to perform a wearing detection function, the control method comprising:
acquiring sensor data including a pressure value between a thigh fastener of the wearable device and a leg of a user from a first pressure sensor;
determining, based on the sensor data, whether the wearable device is properly worn by the user; and
changing an operating mode of the wearable device to an active mode in response to a determination that the wearable device is properly worn by the user.

12. The control method of claim 11, wherein the determining comprises:
determining that the wearable device is properly worn by the user based on the pressure value measured by the first pressure sensor being greater than a reference value.

13. The control method of claim 11, wherein the wearable device comprises a plurality of first pressure sensors located at different positions of the wearable device, and the determining comprises determining that the wearable device is properly worn by the user when each pressure value measured by each of the plurality of first pressure sensors is greater than a reference value.

14. The control method of claim 11, wherein the determining comprises:
determining that the wearable device is not properly worn by the user based on the pressure value measured by the first pressure sensor being less than or equal to the reference value.

15. The control method of claim 14, further comprises:
controlling the wearable device to output at least one of vibration feedback and a guide voice for inducing proper wearing of the wearable device in response to a determination that the wearable device is not properly worn by the user.

16. The control method of claim 11, further comprises:
in the active mode, monitoring a wearing state of the wearable device based on at least one of the pressure value measured by the first pressure sensor and a torque value measured by a torque sensor included in the wearable device.

17. The control method of claim 16, further comprises:
in the active mode, controlling the wearable device to output at least one of vibration feedback and a guide voice for inducing proper wearing of the wearable device in at least one of a case in which the pressure value measured by the first pressure sensor is less than or equal to a first reference value and a case in which the torque value measured by the torque sensor is less than or equal to a second reference value.

18. The control method of claim 11, wherein the wearable device further comprises at least one of a first fastening adjuster located at the thigh fastener of the wearable device and/or a second fastening adjuster located at a waist fastener of the wearable device, and
the control method further comprises controlling a degree of tightening of at least one of the first fastening adjuster and/or the second fastening adjuster based on a pressure value measured by one or more pressure sensors included in the wearable device.

19. The control method of claim 11, further comprising:
acquiring sensor data including a pressure value between a base body of the wearable device and a lumbar region of the user from a second pressure sensor; and
determining whether the wearable device is properly worn by the user, based on the pressure value between the base body and the lumbar region of the user.

20. A computer-readable storage medium storing instructions that, when executed, cause a processor to perform the method of claim 11.
